(19) United States
(12) Patent Application Publication
(10) Pub. No.: US 2016/0311185 A1
(43) Pub. Date: Oct. 27, 2016

(54) CURING BLADDER COMPRISED OF MATERIALS WITH VARYING THERMAL CONDUCTIVITY

(71) Applicant: BRIDGESTONE AMERICAS TIRE OPERATIONS, LLC, Nashville, TN (US)

(72) Inventors: Adam K. Nesbitt, Akron, OH (US); Jason Barr, Akron, OH (US); Robert W. Asper, Wadsworth, OH (US)

(21) Appl. No.: 15/101,971

(22) PCT Filed: Dec. 5, 2014
(86) PCT No.: PCT/US14/68695

§ 371 Date: Jun. 6, 2016

Related U.S. Application Data
(60) Provisional application No. 61/916,134, filed on Dec. 13, 2013.

(51) Int. Cl. B29D 30/06; B29C 33/76

(52) U.S. Cl. CPC B29D 30/0654; B29C 33/76; B29D 2030/0655; B29K 2995/0046; B29L 2022/025

(57) ABSTRACT

Various embodiments of a curing bladder comprised of materials with varying thermal conductivity are disclosed.

### BACKGROUND

When curing a rubber article, such as a tire, a curing bladder is often used in the interior of the rubber article to apply heat and pressure to the rubber article to effect curing, while pressing the rubber article into a mold oriented opposite the curing bladder. Traditionally, a heat source directs heat inside a curing bladder during curing of a rubber article. The heat must pass through the curing bladder and into the rubber article to effect curing.

Additionally, some portions of a rubber article may comprise thicker portions, thinner portions, or specific compounds, any of which may require more or less heat application for optimal curing.

What is needed is a curing bladder comprised of materials having different or varying thermal conductivity coefficients to generally decrease heat and time necessary to cure a rubber article, or to direct more or less heat to specific portions of a rubber article during curing.

### SUMMARY

In one embodiment, a curing bladder is provided, the curing bladder comprising: a first layer comprising a first layer thermal conductivity coefficient; and a second layer comprising at least one material having a thermal conductivity coefficient greater than the thermal conductivity coefficient of the first layer.

In another embodiment, a curing bladder is provided, the curing bladder comprising: a first layer comprising a first layer thermal conductivity coefficient; and a second layer comprising a plurality of second layers, wherein each of the plurality of second layers comprises a material having a thermal conductivity coefficient greater than the thermal conductivity coefficient of the first layer.

In another embodiment, a curing bladder is provided, the curing bladder comprising: a first portion comprising a first strain property; a second portion comprising a second strain property; wherein the first strain property and the second strain property are different.

### BRIEF DESCRIPTION OF THE DRAWINGS

The accompanying figures, which are incorporated in and constitute a part of the specification, illustrate various example configurations, and are used merely to illustrate various example embodiments. In the figures, like elements bear like reference numerals.

FIG. 1 illustrates a cross-sectional view of an example embodiment of a curing bladder.

FIG. 2 illustrates a cross-sectional view of an example embodiment of a curing bladder with heat passing through the curing bladder.

FIG. 3 illustrates a cross-sectional view of an example embodiment of a curing bladder used in conjunction with a tire.

FIG. 4 illustrates a cross-sectional view of an example embodiment of a curing bladder having zones of differing thermal conductivities, with heat passing through the curing bladder.

FIG. 5 illustrates a cross-sectional view of an example embodiment of a curing bladder having zones of differing thermal conductivities, used in conjunction with a tire.

FIG. 6 illustrates a cross-sectional view of an example embodiment of a curing bladder having various portions, used in conjunction with a tire.

### DETAILED DESCRIPTION

When curing rubber articles, such as tires, the uncured rubber article is typically placed within a mold and heated under pressure to a specific temperature for a specific amount of time. A curing bladder is typically placed within the rubber article to provide heat and pressure to the rubber article. The high pressure (for example, on the order of several hundred psi) forces the uncured rubber article into the inner surface of a mold. Heat in the form of super-heated steam, hot water, or any other heating medium may be introduced to and/or circulated within the curing bladder so as to provide heat through the curing bladder and into the uncured rubber article to be cured.

The rise in temperature of the uncured rubber article may cause a chemical reaction (curing, or vulcanization) to occur in the rubber compounds that make up the rubber article, whereby the long polymer molecules become crosslinked together by sulfur or other curatives. The rubber compounds may be transformed in this way into strong, elastic materials in the finished, cured rubber article.

However, applying too much heat to an uncured rubber article, or portions of that article, may have deleterious effects on the performance of the cured article. For example, “over-curing” a rubber article may result in a higher amount of sulfur to sulfur bonds to form in the rubber compounds that make up the rubber article. A cured rubber article having a higher-than-desired number of sulfur to sulfur bonds may also have a higher-than-desired hysteresis.

A rubber having a high hysteresis may not “bounce back” into position as quickly as a rubber with a lower hysteresis. The result of a high hysteresis condition in a rubber article may be an energy loss. Where the cured rubber article is a tire, the result of a high hysteresis may be an increase in the tire's rolling resistance, which may lead to poor fuel economy.

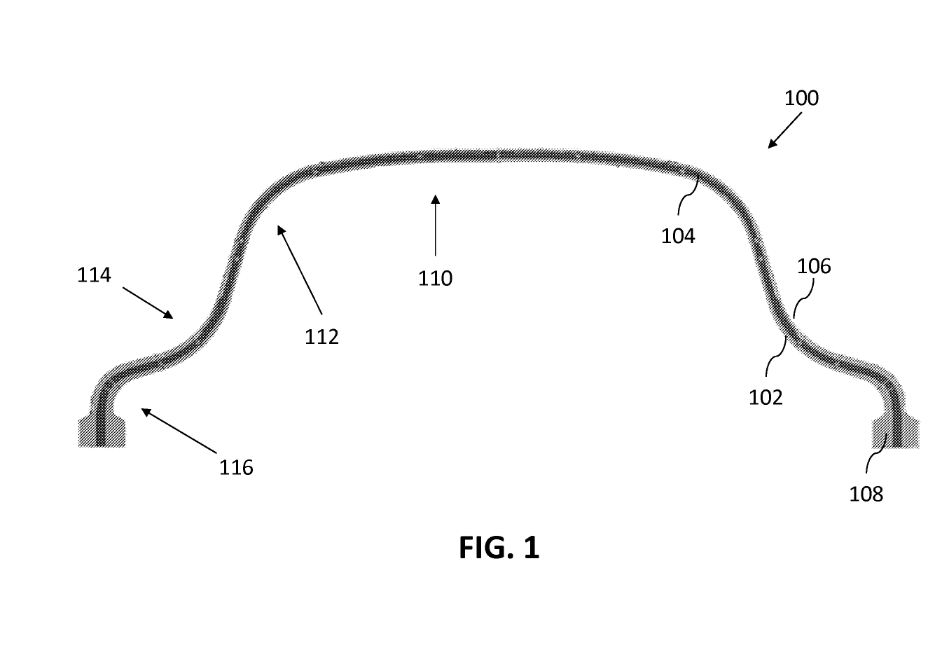

FIG. 1 illustrates a cross-sectional view of an example embodiment of a curing bladder 100. FIG. 1 may illustrate a single section of a curing bladder that is generally shaped like an annulus. In one embodiment, bladder 100 comprises any of a variety of shapes. Bladder 100 may comprise a first layer 102, a second layer 104, and a third layer 106. Bladder 100 may comprise at least one foot 108. In one embodiment, bladder 100 comprises second layer 104, and at least one of first layer 102 and third layer 106.

In one embodiment, bladder 100 comprises a curing bladder for use in curing a rubber article. In another embodiment, bladder 100 comprises a curing bladder for use in curing a rubber tire, including for example a pneumatic tire. In another embodiment, bladder 100 comprises a curing bladder for use in curing a rubber air spring. Bladder 100 may be used in conjunction with a tire mold to cure an uncured tire. In one embodiment, an uncured tire is placed inside a mold, about bladder 100. The mold may be closed, following which bladder 100 may be pressurized such that it expands and presses the uncured tire into the mold.

In one embodiment, a heating medium such as super-heated steam, hot water, or the like is introduced inside curing bladder 100. The heating medium may be configured to pass heat energy through the thickness of bladder 100 and into a rubber article to be cured.

In one embodiment, bladder 100 experiences significant stress and strain during a curing process. In one embodiment, the majority of stress and strain that bladder 100 experiences is along the inner and outer surfaces of bladder 100. In one embodiment, bladder 100 comprises an average value of % stretch between about 5% and about 50%. In another embodiment, bladder 100 comprises an average value of % stretch between about 10% and about 30%.

In one embodiment, bladder 100 may comprise at least two of first layer 102, second layer 104, and third layer 106. That is, in one embodiment, bladder 100 comprises a first layer 102, and a second layer 104, but no third layer 106.

In one embodiment, first layer 102 comprises a material selected to withstand a large amount of stress and strain. In another embodiment, first layer 102 comprises a material selected to withstand a large amount of compression force. In another embodiment, first layer 102 comprises a material selected to withstand a large amount of stress and strain, and particularly a large amount of compression force. In one embodiment, first layer 102 comprises an average value of % stretch between about 5% and about 50%. In another embodiment, first layer 102 comprises an average value of % stretch between about 10% and about 30%.

In one embodiment, first layer 102 comprises a rubber. In another embodiment, first layer 102 comprises a polymer. In another embodiment, first layer 102 comprises any of a variety of materials, including for example, a metal, an alloy, or a composite. In one embodiment, first layer 102 comprises a flexible material. In one embodiment, first layer 102 comprises an first layer thermal conductivity coefficient. In one embodiment, first layer 102 comprises an first layer thermal conductivity coefficient of about 0.113 W/(m*K). In another embodiment, first layer 102 comprises an first layer thermal conductivity coefficient of between about 0.084 W/(m*K) and about 0.141 W/(m*K). In another embodiment, first layer 102 comprises an first layer thermal conductivity coefficient of between about 0.098 W/(m*K) and about 0.127 W/(m*K). In one embodiment, at least one of first layer 102, second layer 104, and third layer 106 comprises a thermal conductivity coefficient of between about 0.084 W/(m*K) and about 0.141 W/(m*K). In one embodiment, first layer 102 comprises a first layer thermal conductivity coefficient that is different from at least one of a second layer thermal conductivity coefficient and a third layer thermal conductivity coefficient.

In one embodiment, first layer 102 comprises a substantially constant thickness throughout the axial width of bladder 100. In another embodiment, first layer 102 comprises a varying thickness through the axial width of bladder 100, such that first layer 102 is thicker in some portions than in other portions.

In one embodiment, third layer 106 comprises a material selected to withstand a large amount of stress and strain. In another embodiment, third layer 106 comprises a material selected to withstand a large amount of tensile force. In another embodiment, third layer 106 comprises a material selected to withstand a large amount of stress and strain, and particularly a large amount of tensile force. In one embodiment, third layer 106 comprises an average value of % stretch between about 5% and about 50%. In another embodiment, third layer 106 comprises an average value of % stretch between about 10% and about 30%.

In one embodiment, third layer 106 comprises a rubber. In another embodiment, third layer 106 comprises a polymer. In another embodiment, third layer 106 comprises any of a variety of materials, including for example, a metal, an alloy, or a composite. In one embodiment, third layer 106 comprises a flexible material. In one embodiment, third layer 106 comprises an third layer thermal conductivity coefficient. In one embodiment, third layer 106 comprises an third layer thermal conductivity coefficient of about 0.113 W/(m*K). In another embodiment, third layer 106 comprises an third layer thermal conductivity coefficient of between about 0.084 W/(m*K) and about 0.141 W/(m*K). In another embodiment, third layer 106 comprises an third layer thermal conductivity coefficient of between about 0.098 W/(m*K) and about 0.127 W/(m*K). In one embodiment, at least one of first layer 102, second layer 104, and third layer 106 comprises a thermal conductivity coefficient of between about 0.084 W/(m*K) and about 0.141 W/(m*K). In one embodiment, third layer 106 comprises a third layer thermal conductivity coefficient that is different from at least one of a second layer thermal conductivity coefficient and a first layer thermal conductivity coefficient.

In one embodiment, third layer 106 comprises a substantially constant thickness throughout the axial width of bladder 100. In another embodiment, third layer 106 comprises a varying thickness through the axial width of bladder 100, such that third layer 106 is thicker in some portions than in other portions.

In one embodiment, second layer 104 comprises a material selected to provide increased thermal conductivity. In one embodiment, second layer 104 comprises a second layer thermal conductivity coefficient. In another embodiment, the second layer thermal conductivity coefficient is greater than the first layer thermal conductivity coefficient and the third layer thermal conductivity coefficient. In one embodiment, second layer 104 comprises a second layer thermal conductivity coefficient of about 0.141 W/(m*K). In another embodiment, second layer 104 comprises a second layer thermal conductivity coefficient of between about 0.113 W/(m*K) and about 0.170 W/(m*K). In another embodiment, second layer 104 comprises a second layer thermal conductivity coefficient of between about 0.127 W/(m*K) and about 0.156 W/(m*K). In one embodiment, at least one of first layer 102, second layer 104, and third layer 106 comprises a thermal conductivity coefficient of between about 0.113 W/(m*K) and about 0.170 W/(m*K). In one embodiment, second layer 104 comprises a second layer thermal conductivity coefficient that is different from at least one of a first layer thermal conductivity coefficient and a third layer thermal conductivity coefficient.

In one embodiment, second layer 104 comprises a rubber. In another embodiment, second layer 104 comprises a polymer. In another embodiment, second layer 104 comprises a metal. In another embodiment, second layer 104 comprises any of a variety of materials having a thermal conductivity coefficient greater than the first layer thermal conductivity coefficient and the third layer thermal conductivity coefficient, including for example, a metal, an alloy, or a composite. In one embodiment, second layer 104 comprises a flexible material.

In one embodiment, second layer 104 comprises a substantially constant thickness throughout the axial width of bladder 100. In another embodiment, second layer 104 comprises a varying thickness through the axial width of bladder 100, such that second layer 104 is thicker in some portions than in other portions.

In one embodiment, first layer 102 and third layer 106 comprise at least substantially all of the strength required in bladder 100 to successfully cure a rubber article. Second layer 104 may contribute, at least partially, to the strength required in bladder 100 to successfully cure a rubber article. Second layer 104 may permit heat from within bladder 100 to pass through bladder 100 (that is, pass through first layer 102, second layer 104, and third layer 106) and into an uncured rubber article more quickly, such that cure time of the rubber article is reduced. In another embodiment, second layer 104 permits increased heat transfer from within bladder 100 into an uncured rubber article. As a result, less heat (and possibly lower temperatures) may be needed within bladder 100 to effectively cure an uncured rubber article.

In one embodiment, at least two of first layer 102, second layer 104, and third layer 106 are laminated to form at least a portion of bladder 100. In one embodiment, first layer 102 is oriented radially inwardly relative to at least one of second layer 104 and third layer 106. In another embodiment, third layer 106 is oriented radially outwardly relative to at least one of first layer 102 and second layer 104. In another embodiment, second layer 104 is oriented radially inwardly relative to third layer 106 and radially outwardly relative to first layer 102. In another embodiment, second layer 104 is oriented radially inwardly relative to at least one of first layer 102 and third layer 106. In another embodiment, second layer 104 is oriented radially outwardly relative to at least one of first layer 102 and third layer 106.

At least two of first layer 102, second layer 104, and third layer 106, may comprise a combined thickness between about 1.5 mm and about 15.0 mm. In another embodiment, at least two of first layer 102, second layer 104, and third layer 106, comprise a combined thickness between about 2.5 mm and about 13.0 mm. In another embodiment, at least two of first layer 102, second layer 104, and third layer 106, comprise a combined thickness between about 3.0 mm and about 10.0 mm. In another embodiment, at least two of first layer 102, second layer 104, and third layer 106, comprise a combined thickness between about 4.0 mm and about 8.0 mm. In another embodiment, at least two of first layer 102, second layer 104, and third layer 106, comprise a combined thickness greater than about 3.0 mm.

In one embodiment, at least two of first layer 102, second layer 104, and third layer 106, comprise a combined thickness that is substantially constant throughout the axial width of bladder 100. In another embodiment, at least two of first layer 102, second layer 104, and third layer 106, comprise a combined thickness that varies throughout the axial width of bladder 100. In one embodiment, the combined thickness of at least two of first layer 102, second layer 104, and third layer 106 may be less at points in bladder 100 where less strength is necessary. In another embodiment, the combined thickness of at least two of first layer 102, second layer 104, and third layer 106 may be greater at points in bladder 100 where more strength is necessary. In another embodiment, the combined thickness of at least two of first layer 102, second layer 104, and third layer 106 may be less at points in bladder 100 where more heat transfer is necessary. In another embodiment, the combined thickness of at least two of first layer 102, second layer 104, and third layer 106 may be greater at points in bladder 100 where less strength is necessary. In another embodiment, the combined thickness of at least two of first layer 102, second layer 104, and third layer 106 may be about the same at two points in bladder 100, but the thickness of second layer 104 may be increased or decreased depending upon the amount of heat that is to be applied to a specific portion of an uncured rubber article. In another embodiment, the thickness of any of first layer 102, second layer 104, and third layer 106 may be varied as necessary to achieve a desired strength in a specific point in bladder 100, while achieving the desired heat transfer in that same point.

In one embodiment, bladder 100 comprises at least one foot 108. In one embodiment, bladder 100 is configured for curing a tire, an comprises two feet 108. At least one foot 108 may comprise an portion of bladder 100 configured to mount bladder 100 into a molding device. In one embodiment, at least one foot 108 is a thickened portion of bladder 100. In another embodiment, at least one foot 108 comprises a profile configured to mold a specific portion of a rubber article, which in the case of a tire, may comprise the bead portion of the tire.

In one embodiment, bladder 100 is configured for curing a tire. Bladder 100 may comprise any of various zones, including for example a tread zone 110, a shoulder zone 112, a sidewall zone 114, and a bead zone 116. In one embodiment, the thickness of at least one of first layer 102, second layer 104, and third layer 106 may be increased or decreased in any of various zones to at least one of: (a) increase or decrease strength of bladder 100 in the desired zone; and (b) increase or decrease the thermal conductivity/heat transfer in the desired zone.

As an example, tires may have more material, with a greater thickness, in a shoulder region of the tire versus the sidewall region of the tire. As a result, it may take more heat energy to properly cure the tire's shoulder region than the tire's sidewall region. A tire's shoulder region may correspond with bladder 100's shoulder zone 112, and a tire's sidewall region may correspondence with bladder 100's sidewall zone 114. In one embodiment the second layer thermal conductivity coefficient in shoulder zone 112 is greater than the second layer thermal conductivity coefficient in sidewall zone 114. As a result, heat is more readily transferred through shoulder zone 112 to the shoulder region of the tire, than through sidewall zone 114 to the sidewall region of the tire. The tire may accordingly have optimal heat applied to both the shoulder region and the sidewall region, resulting in proper curing of each region without undesirably increased hysteresis.

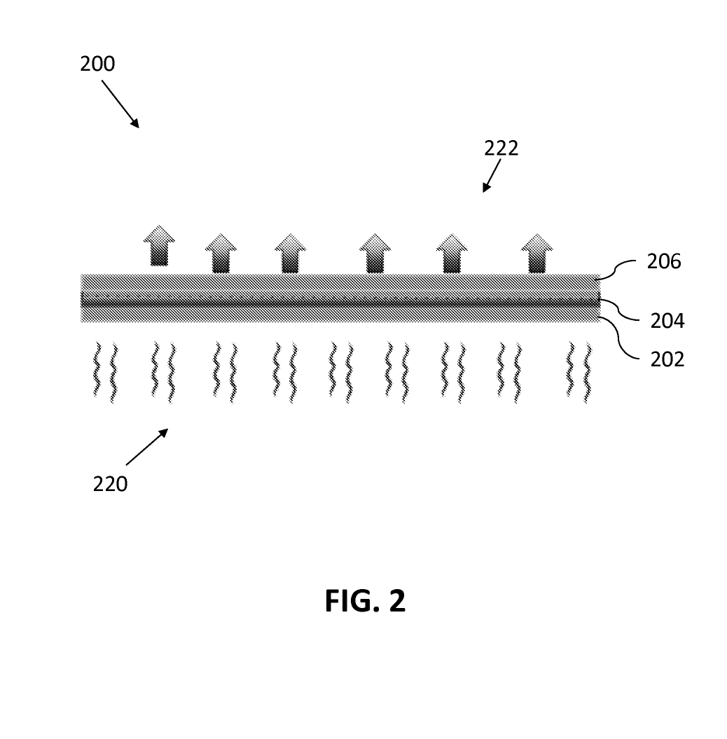

FIG. 2 illustrates a cross-sectional view of an example embodiment of a curing bladder 200 with heat passing through curing bladder 200. Curing bladder 200 may comprise a first layer 202, a second layer 204, and a third layer 206.

Heat, represented at 220, from a heating medium within bladder 200 is applied to first layer 202. Heat 220 conducts through first layer 202, into second layer 204. Second layer 204 conducts heat into third layer 206, which heat is then introduced into the uncured rubber article outside bladder 200 at 222. Second layer 204, comprising a higher thermal conductivity coefficient than first layer 202 and third layer 206, conducts heat at a faster rate than first layer 202 and third layer 206.

In one embodiment, curing bladder 200 comprises at least two of first layer 202, second layer 204, and third layer 206, wherein the thermal conductivity coefficient of one of the at least two is different from another of the at least two.

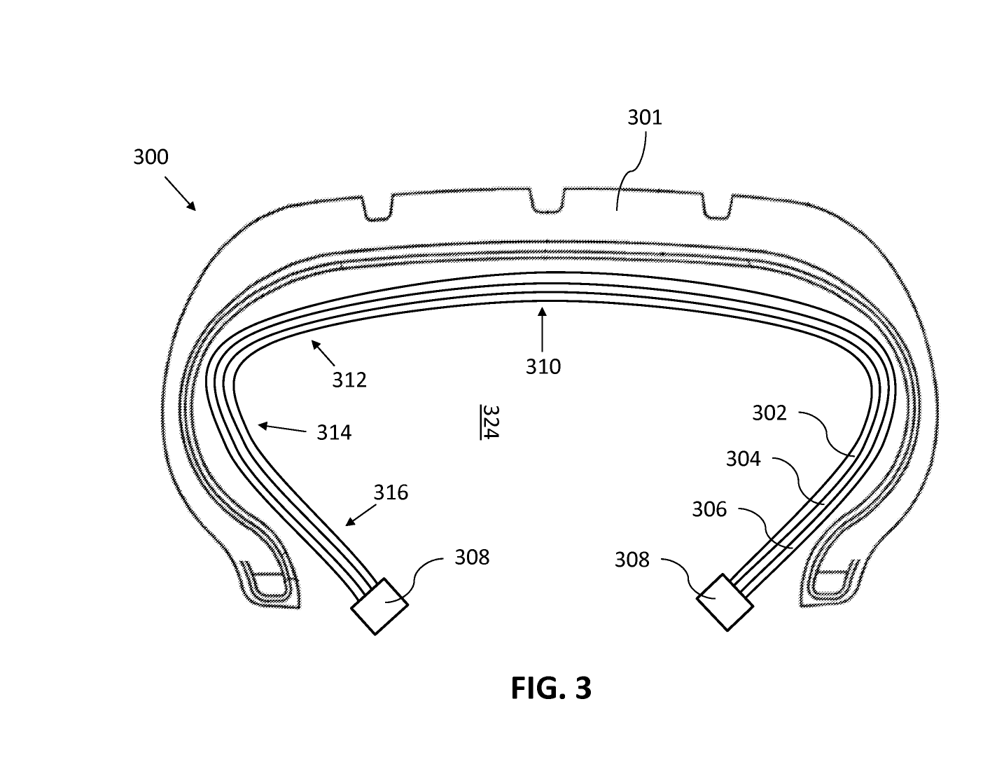

FIG. 3 illustrates a cross-sectional view of an example embodiment of a curing bladder 300 used to cure a tire 301. FIG. 3 may illustrate a single section of a curing bladder that is generally shaped like an annulus. In one embodiment, bladder 300 comprises any of a variety of shapes.

FIG. 3 illustrates bladder 300 in a partially deflated state. During curing of a tire 301, bladder 300 may substantially contact the interior of tire 301 Likewise, bladder 300 may be shaped in such a manner so as to contact the interior of tire 301 when inflated.

Bladder 300 may comprise at least two of a first layer 302, a second layer 304, and a third layer 306. Bladder 300 may comprise at least one foot 308. Bladder 300 may comprise any of various zones, including for example a tread zone 310 corresponding to tire 301's tread region, a shoulder zone 312 corresponding to tire 301's shoulder region, a sidewall zone 314 corresponding to tire 301's sidewall region, and a bead zone 316 corresponding to tire 301's bead region.

In the case of bladder 300 being used to cure tire 301, the various zones illustrated may be applicable on either side of the tire. That is, FIG. 3 illustrates the zones extending along the left side of bladder 300, but it is contemplated that these same zones, or different zones, may also exist on the right side of bladder 300. In one embodiment, bladder 300 comprises more or less zones than illustrated in FIG. 3. It is contemplated that bladder 300 could comprise one or more zone.

Heat from a heating medium may be applied to the bladder interior 324. As described above, this heat may conduct through first layer 302, second layer 304, and third layer 306 into tire 301. In one embodiment, curing bladder 300 comprises at least two of first layer 302, second layer 304, and third layer 306, wherein the thermal conductivity coefficient of one of the at least two is different from another of the at least two.

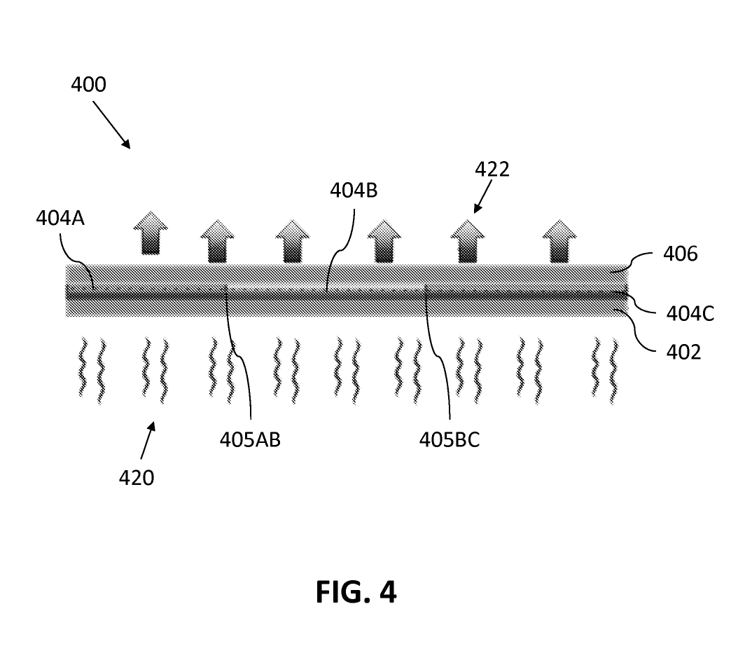

FIG. 4 illustrates a cross-sectional view of an example embodiment of a curing bladder 400 with zones of differing thermal conductivity. Curing bladder 400 may comprise a first layer 402, a first second layer 404A, a second second layer 404B, and a third second layer 404C. Bladder 400 may comprise a junction 405AB between first second layer 404A and second second layer 404B. Bladder 400 may also comprise a junction 405BC between second second layer 404B and third second layer 404C. Bladder may comprise a third layer 406.

Heat, represented at 420, from a heating medium within bladder 400 is applied to first layer 402. Heat 420 conducts through first layer 402, into first second layer 404A, second second layer 404B, and third second layer 404C. Each of first second layer 404A, second second layer 404B, and third second layer 404C may comprise materials having different thermal conductivity coefficients. In another embodiment, one or more of first second layer 404A, second second layer 404B, and third second layer 404C comprise materials having different, or the same, thermal conductivity coefficients. For example, first second layer 404A may comprise a greater thermal conductivity coefficient than second second layer 404B. As a result, first second layer 404A may conduct heat 420 at a faster rate than second second layer 404B. First second layer 404A, second second layer 404B, and third second layer 404C may conduct heat into third layer 406, which heat is then introduced into the uncured rubber article outside bladder 400 at 422. First second layer 404A, second second layer 404B, and third second layer 404C may comprise thermal conductivity coefficients greater than, substantially equal to, or less than first layer 402 and third layer 404, as necessary to properly cure an uncured rubber article.

In one embodiment, curing bladder 400 comprises first second layer 404A, second second layer 404B, and third second layer 404C, and at least one of first layer 402 and third layer 406.

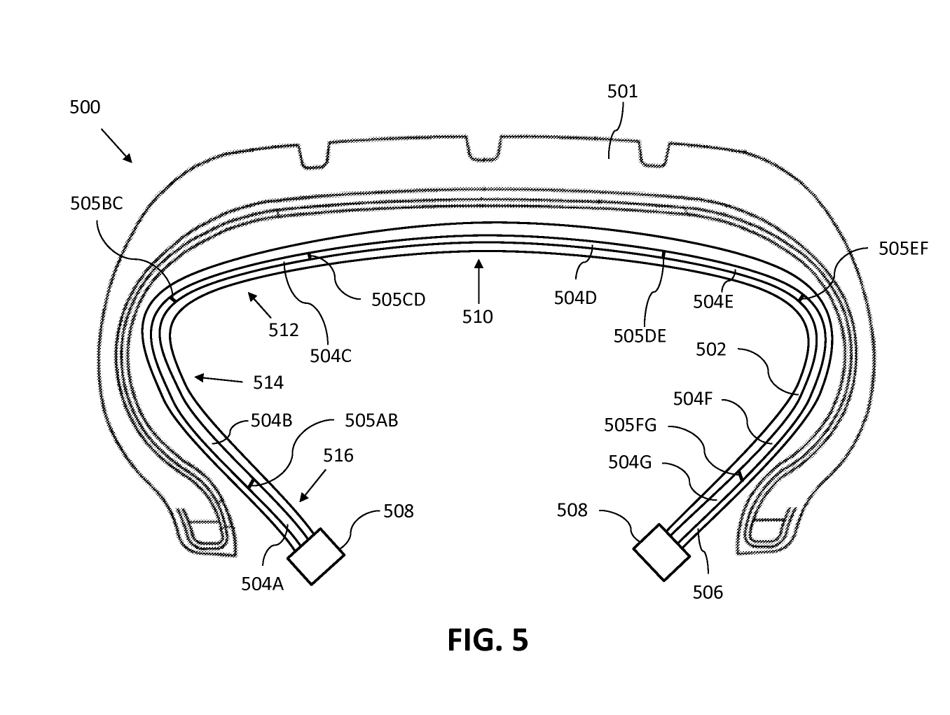

FIG. 5 illustrates bladder 500 in a partially deflated state. During curing of a tire 501, bladder 500 may substantially contact the interior of tire 501 Likewise, bladder 500 may be shaped in such a manner so as to contact the interior of tire 501 when inflated.

Bladder 500 may comprise a first layer 502, a first second layer 504A, a second second layer 504B, a third second layer 504C, a fourth second layer 504D, a fifth second layer 504E, a sixth second layer 504F, and a seventh second layer 504G. Bladder 500 may comprise a junction 505AB between first second layer 504A and second second layer 504B, a junction 505BC between second second layer 504B and third second layer 504C, a junction 505CD between third second layer 504C and fourth second layer 504D, a junction 505DE between fourth second layer 504D and fifth second layer 504E, a junction 505EF between fifth second layer 504E and sixth second layer 504F, and a junction 505FG between sixth second layer 504F and seventh second layer 504G. It is contemplated that bladder 500 can include any number of second layers 504. In one embodiment, bladder 500 comprises one or more second layer 504.

Bladder 500 may additionally comprise a third layer 506. Bladder 500 may comprise at least one foot 508. Bladder 500 may comprise any of various zones, including for example a tread zone 510 corresponding to tire 501's tread region, a shoulder zone 512 corresponding to tire 501's shoulder region, a sidewall zone 514 corresponding to tire 501's sidewall region, and a bead zone 516 corresponding to tire 501's bead region.

In the case of bladder 500 being used to cure tire 501, the various zones illustrated may be applicable on either side of the tire. That is, FIG. 5 illustrates the zones extending along the left side of bladder 500, but it is contemplated that these same zones, or different zones, may also exist on the right side of bladder 500. In one embodiment, bladder 500 comprises more or less zones than illustrated in FIG. 5. It is contemplated that bladder 500 could comprise one or more zone.

In one embodiment, first second layer 504A and seventh second layer 504G correspond to bead zone 516 (and a second bead zone oriented opposite bead zone 516). In another embodiment, second second layer 504B and sixth second layer 504F correspond to sidewall zone 514 (and a second sidewall zone oriented opposite sidewall zone 514. In another embodiment, third second layer 504C and fifth second layer 504E correspond to shoulder zone 512 (and a second shoulder zone oriented opposite shoulder zone 512). In another embodiment, fourth second layer 504D correspondents to tread zone 510.

In one embodiment, one or more of first second layer 504A, second second layer 504B, third second layer 504C, fourth second layer 504D, fifth second layer 504E, sixth second layer 504F, and seventh second layer 504G comprise different thermal conductivity coefficients. Thermal conductivity coefficients may be selected to increase or decrease the rate of heat transfer to a specific part of tire 501. For example, third second layer 504C and fifth second layer 504E, corresponding to the shoulder regions of tire 501, may have a higher thermal conductivity coefficient than second second layer 504B and sixth second layer 504F, corresponding to the sidewall regions of tire 501. As a result, a heat applied inside bladder 500 more readily conducts through third second layer 504C and fifth second layer 504E than second second layer 504B and sixth second layer 504F, so as to apply more heat to the shoulder regions of tire 501 and less heat to the sidewall regions of tire 501. In this manner, the same heat supplied inside bladder 500 can be used for the same amount of time to properly cure both the shoulder regions and sidewall regions of tire 500 without creating an undesirably high amount of hysteresis in either of the regions.

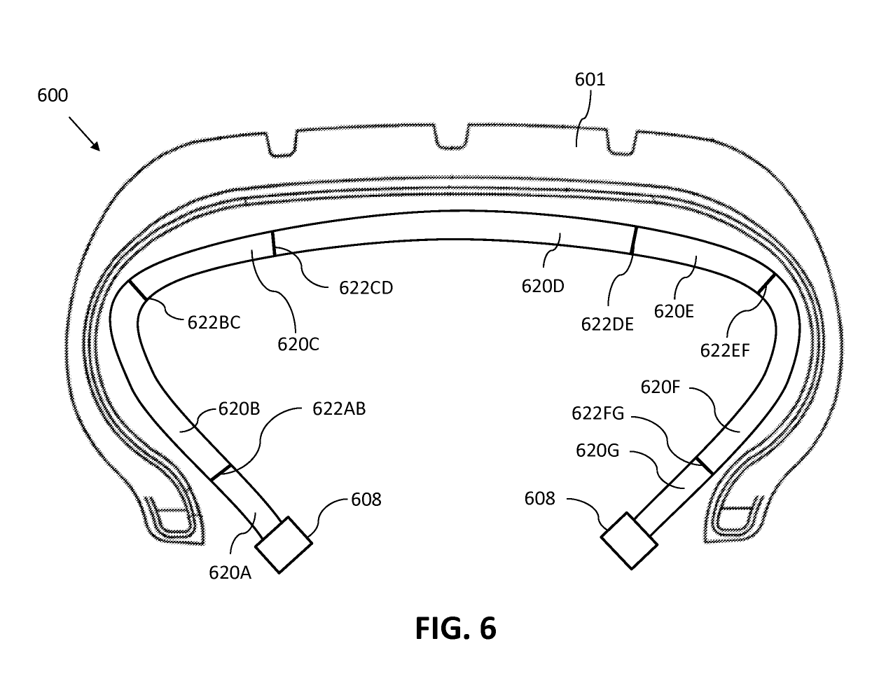

FIG. 6 illustrates bladder 600 in a partially deflated state. During curing of a tire 601, bladder 600 may substantially contact the interior of tire 601 Likewise, bladder 600 may be shaped in such a manner so as to contact the interior of tire 601 when inflated.

Bladder 600 may comprise at least one foot 608. In one embodiment, bladder 600 comprises a plurality of portions 620. In one embodiment, bladder 600 may comprise a first portion 620A, a second portion 620B, a third portion 620C, a fourth portion 620D, a fifth portion 620E, a sixth portion 620F, and a seventh portion 620G. Bladder 600 may comprise a junction 622AB between first portion 620A and second portion 620B, a junction 622BC between second portion 620B and third portion 620C, a junction 622CD between third portion 620C and fourth portion 620D, a junction 622DE between fourth portion 620D and fifth portion 620E, a junction 622EF between fifth portion 620E and sixth portion 620F, and a junction 622FG between sixth portion 620F and seventh portion 620G. It is contemplated that bladder 600 can include any number of portions 620. In one embodiment, bladder 600 comprises one or more portion 620. In another embodiment, bladder comprises one or more layers of portions 620, which may be oriented radially inwardly and/or outwardly from one another.

In one embodiment, bladder 600 comprises any of portions 620A-G, any one or more of which may comprise different strain properties. In one embodiment, portions 620A-G comprise varying strain properties. For example, at least one of portions 620A-G comprise a greater or lesser % stretch and another of portions 620A-G. In practice, a portion 620 comprising a higher % stretch may be optimized for contacting a rubber article having a smaller radius of curvature, whereas a portion 620 comprising a lower % stretch may be optimized for contacting a rubber article having a planar profile or larger radius of curvature. In one embodiment, bladder 600 having portions 620A-G with varying strain properties is exposed to a uniform internal pressure that acts the same against all portions 620A-G. However, as portions 620A-G have varying strain properties, some of portions 620A-G may displace differently in response to the uniform internal pressure. For example, some of portions 620A-G may comprise a higher % stretch property that allows that portion to fit into tighter radius of curvature by displacing differently in response to uniform internal pressure.

In the case of bladder 600 being used to cure tire 601, portions 620A-G may correspond to various regions in tire 601, such as the bead region, sidewall region, shoulder region, and tread region. In one embodiment, first portion 620A and seventh portion 620G correspond to the bead regions of tire 601. In another embodiment, second portion 620B and sixth portion 620F correspond to the sidewall regions of tire 601. In another embodiment, third portion 620C and fifth portion 620E correspond to the shoulder regions of tire 601. In another embodiment, fourth portion 620D corresponds to the tread region of tire 601. It is contemplated that more or less portions 620 may correspond to more or less regions of tire 601 not specifically noted herein.

In one embodiment, third portion 620C and fifth portion 620E correspond to the shoulder regions of tire 601. Third portion 620C and fifth portion 620E may comprise greater % stretch properties than one or more of portions 620A, B, D, F, and G. A uniform pressure applied to the interior of bladder 600 may cause third portion 620C and fifth portion 620E to displace in such as manner as to conform better to the tighter radius of curvature that may be experienced at the shoulder regions of tire 601. Optimization of the conformity of bladder 600 to tire 601 may optimize heat transfer across bladder 600 and into tire 601.

In one embodiment, bladder 600 may additionally comprise at least one first layer, second layer, or third layer (not shown) comprising one or more thermal conductivity coefficient. In another embodiment, one or more of portions 620 may comprise one or more thermal conductivity coefficient. In one embodiment, bladder 600 may comprise one or more thermal conductivity coefficients and one or more strain properties.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to indicate a nature of an element and/or a relationship between elements within a reasonable degree of precision and tolerance as is acceptable in the relevant field of technology. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A curing bladder, comprising:
a first layer comprising a first layer thermal conductivity coefficient; and
a second layer comprising at least one material having a thermal conductivity coefficient greater than the thermal conductivity coefficient of the first layer.

2. The curing bladder of claim 1, further comprising a third layer comprising a third layer thermal conductivity coefficient.

3. The curing bladder of claim 2, wherein the third layer comprises at least one material having material properties to withstand a high stress, a high strain, and a high tensile force.

4. The curing bladder of claim 1, wherein the first layer comprises at least one material having material properties to withstand a high stress, a high strain, and a high compressive force.

5. The curing bladder of claim 1, wherein the curing bladder is configured for use in curing a tire.

6. The curing bladder of claim 1, wherein the second layer comprises a plurality of second layers, and wherein each of the plurality of second layers comprises a material having a thermal conductivity coefficient.

7. The curing bladder of claim 6, wherein each of the plurality of second layers comprises a thermal conductivity coefficient that is either the same as, or different from, the other second layers.

8. The curing bladder of claim 1, wherein the curing bladder comprises a plurality of zones.

9. The curing bladder of claim 5, wherein the curing bladder comprises a plurality of zones, including at least one shoulder zone, at least one sidewall zone, and a tread zone.

10. The curing bladder of claim 9, wherein the second layer comprises a plurality of second layers, wherein each of the plurality of second layers comprises a material having a thermal conductivity coefficient, and wherein a second layer corresponding to the at least one shoulder zone comprises a higher thermal conductivity coefficient than a second layer corresponding to the at least one sidewall zone.

11. The curing bladder of claim 9, wherein the second layer comprises a plurality of second layers, wherein each of the plurality of second layers comprises a material having a thermal conductivity coefficient, and wherein a second layer corresponding to the at least one shoulder zone comprises a higher thermal conductivity coefficient than a second layer corresponding to the tread zone.

12. The curing bladder of claim 9, wherein the second layer comprises a plurality of second layers, wherein each of the plurality of second layers comprises a material having a thermal conductivity coefficient, and wherein a second layer corresponding to the tread zone comprises a higher thermal conductivity coefficient than a second layer corresponding to the at least one sidewall zone.

13. A curing bladder, comprising:
a first layer comprising a first layer thermal conductivity coefficient; and
a second layer comprising a plurality of second layers, wherein each of the plurality of second layers comprises a material having a thermal conductivity coefficient greater than the thermal conductivity coefficient of the first layer.

14. The curing bladder of claim 13, further comprising a third layer comprising a third layer thermal conductivity coefficient.

15. The curing bladder of claim 14, wherein the third layer comprises at least one material having material properties to withstand a high stress, a high strain, and a high tensile force.

16. The curing bladder of claim 13, wherein the first layer comprises at least one material having material properties to withstand a high stress, a high strain, and a high compressive force.

17. The curing bladder of claim 13, wherein the curing bladder is configured for use in curing a tire.

18. The curing bladder of claim 13, wherein each of the plurality of second layers comprises a thermal conductivity coefficient that is either the same as, or different from, the other second layers.

19. The curing bladder of claim 13, wherein the curing bladder comprises a plurality of zones.

20. The curing bladder of claim 17, wherein the curing bladder comprises a plurality of zones, including at least one shoulder zone, at least one sidewall zone, and a tread zone.

21. The curing bladder of claim 20, wherein a second layer corresponding to the at least one shoulder zone comprises a higher thermal conductivity coefficient than a second layer corresponding to the at least one sidewall zone.

22. The curing bladder of claim 20, wherein a second layer corresponding to the at least one shoulder zone comprises a higher thermal conductivity coefficient than a second layer corresponding to the tread zone.

23. A curing bladder, comprising:
a first portion comprising a first strain property;
a second portion comprising a second strain property;
wherein the first strain property and the second strain property are different.

24. The curing bladder of claim 23, wherein the curing bladder is configured for use in curing a tire.

25. The curing bladder of claim 24, wherein the first portion corresponds to a shoulder region of the tire, and wherein the first portion comprises a first strain property selected to permit the first portion to conform to the shoulder region of the tire.

26. The curing bladder of claim 23, wherein at least one of the first strain property and the second strain property comprise a % stretch.

27. The curing bladder of claim 23, further comprising:
an third layer comprising an third layer thermal conductivity coefficient;
an first layer comprising an first layer thermal conductivity coefficient; and
a second layer comprising at least one material having a thermal conductivity coefficient greater than the thermal conductivity coefficient of the third layer and the first layer.
